(19) United States
(12) Patent Application Publication
(10) Pub. No.: US 2009/0068448 A1
(43) Pub. Date: Mar. 12, 2009

(54) CARBON NANOTUBE COMPOSITE FILM AND METHOD FOR MAKING THE SAME

(75) Inventors: Chang-Hong Liu, Beijing (CN); Shou-Shan Fan, Beijing (CN)

Correspondence Address: PCE INDUSTRY, INC.;ATT. CHENG-JU CHIANG, 458 E. LAMBERT ROAD, FULLERTON, CA, 92835, US

(73) Assignees: TSINGHUA UNIVERSITY, Beijing (CN); HON HAI PRECISION INDUSTRY CO., LTD., Taipei Hsien (TW)

(21) Appl. No.: 11/967,125

(22) Filed: Dec. 29, 2007

(30) Foreign Application Priority Data
Sep. 7, 2007 (CN) 200710077025.1

(51) Int. Cl. B32B 5/18; B05D 3/12

(52) U.S. Cl. 428/336; 428/408; 427/369; 977/742

(57) ABSTRACT

A carbon nanotube composite film includes at least one carbon nanotube layer and at least one base material layer. A method for making a carbon nanotube composite film includes the steps of: (a) providing a substrate having a carbon nanotube array formed thereon; (b) providing a base material layer, and covering the base material layer on the carbon nanotube array; (c) providing a pressing device, and pressing the carbon nanotube array with the base material layer covered thereon by the pressing device to form a carbon nanotube layer and thus acquiring a carbon nanotube composite film.

### BACKGROUND

1. Field of the Invention

The present invention relates to composite films and method for making the same, particularly, to a carbon nanotube composite film and a method for making the carbon nanotube composite film.

2. Discussion of Related Art

Carbon nanotubes (CNTs) are a novel carbonaceous material and received a great deal of interest since the early 1990s. CNTs have a high Young's modulus, high thermal conductivity, and high electrical conductivity. Due to these and the other properties, it has been suggested that CNTs can play an important role in fields such as microelectronics, material science, biology, and chemistry.

Carbon nanotubes together with other materials can be used to form composite materials. The composites with carbon nanotubes therein have a high strength enhancement, a high flexibility, and are of great interest to technological applications. Carbon nanotube composite films are one of the important technological applications of carbon nanotube composites.

Conventional methods for making carbon nanotube composite film are screen-printing method, rotary coating method, carbon materials pyrolysis method and chemical liquid deposition method. The carbon nanotube composite films prepared by the aforementioned methods have compact structures. However, these methods are complicated, the carbon nanotube composite films generally have only a single-layer film structure, and the carbon nanotubes therein are randomly distributed along all directions. Thus the mechanical strength and toughness of the carbon nanotube composite film are poor, and as a result reduces the thermal and electrical properties of the carbon nanotube composite film.

What is needed, therefore, is a carbon nanotube composite film and method for making the same, the carbon nanotube composite film having good mechanical strength and toughness, and the method being simple and easy to be realized.

### SUMMARY

In one embodiment, a carbon nanotube composite film includes at least one carbon nanotube layer and at least one base material layer. A method for making a carbon nanotube composite film includes the steps of: (a) providing a substrate having a carbon nanotube array formed thereon; (b) providing a base material layer, and covering the base material layer on the carbon nanotube array; (c) providing a pressing device, and pressing the carbon nanotube array with the base material layer covered thereon by the pressing device to form a carbon nanotube layer and thus acquiring a carbon nanotube composite film.

Other advantages and novel features of the present carbon nanotube composite film and method for making the same will become more apparent from the following detailed description of preferred embodiments when taken in conjunction with the accompanying drawings.

### BRIEF DESCRIPTION OF THE DRAWINGS

Many aspects of the present carbon nanotube composite film and method for making the same can be better understood with reference to the following drawings. The components in the drawings are not necessarily to scale, the emphasis instead being placed upon clearly illustrating the principles of the present carbon nanotube composite film and method for making the same.

FIG. 1 is a schematic view of a two-layer carbon nanotube composite film, in accordance with a first present embodiment.

FIG. 2 is a flow chart of a method for making a two-layer carbon nanotube composite film, in accordance with a first embodiment.

FIG. 3 is a structural schematic view of a three-layer carbon nanotube composite film, in accordance with a second embodiment.

FIG. 4 is a structural schematic view of a three-layer carbon nanotube composite film, in accordance with a third embodiment.

FIG. 5 is a structural schematic view of a three-layer carbon nanotube composite film, in accordance with a fourth embodiment.

Corresponding reference characters indicate corresponding parts throughout the several views. The exemplifications set out herein illustrate at least one preferred embodiment of the present carbon nanotube composite film and method for making the same, in at least one form, and such exemplifications are not to be construed as limiting the scope of the invention in any manner.

### DETAILED DESCRIPTION OF PREFERRED EMBODIMENTS

Reference will now be made to the drawings to describe, in detail, embodiments of the present carbon nanotube composite film and a method for making the same.

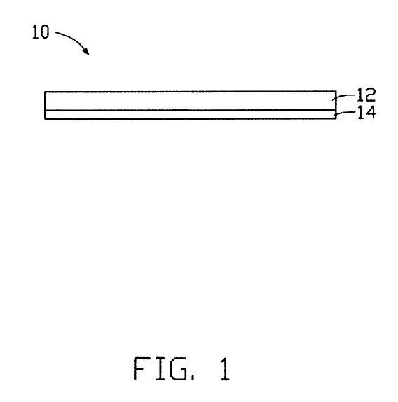

Referring to FIG. 1, a carbon nanotube composite film, according to a first embodiment, has a two-layer structure and includes a carbon nanotube layer and a base material layer.

The carbon nanotube layer has a free-standing structure constituted by a plurality of carbon nanotubes and the plurality of carbon nanotubes are parallel to a surface of the carbon nanotube layer. The carbon nanotube layer and the base material layer are combined firmly by van der Waals attractive force. The carbon nanotubes in the two-layer carbon nanotube composite film are isotropically arranged, arranged along a fixed direction, or arranged along different directions. A thickness of the carbon nanotube layer is in an approximate range from 1 micrometer to 1 millimeter. A thickness of the two-layer carbon nanotube composite film is in an approximate range from 5 micrometers to 1 millimeter. The material of the base material layer can be selected from a group consisting of metal material, metal oxide material, semiconductor material, and polymer material.

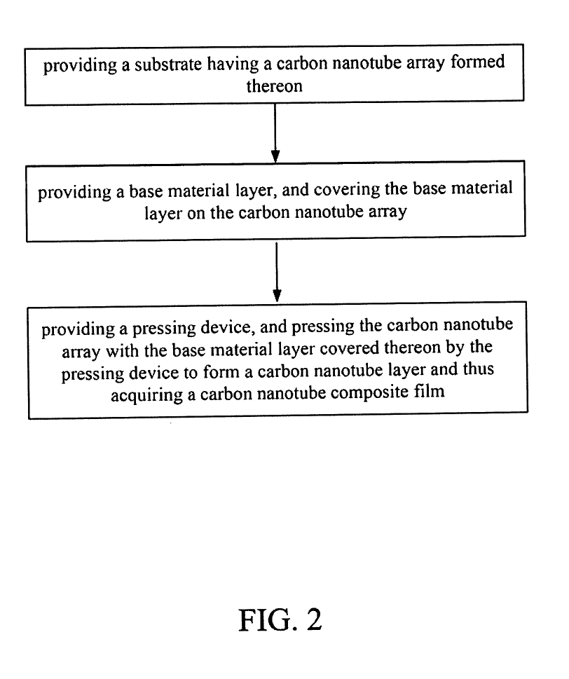

Referring to FIG. 2, a method for making a two-layer carbon nanotube composite film 10 includes the steps of: (a) providing a substrate having a carbon nanotube array formed thereon; (b) providing a base material layer 12, and covering the base material layer 12 on the carbon nanotube array; (c) providing a pressing device, and pressing the carbon nanotube array with the base material layer 12 covered thereon by the pressing device to form a carbon nanotube layer 14 and thus acquiring a two-layer carbon nanotube composite film 10.

In step (a), the carbon nanotube array is a super-aligned array of carbon nanotubes, the super-aligned array of carbon nanotubes can be formed by the steps of: (a1) providing a substantially flat and smooth substrate; (a2) forming a catalyst layer on the substrate; (a3) annealing the substrate with the catalyst layer thereon in air at a temperature in an approximate range from 700° C. to 900° C. for about 30 to 90 minutes; (a4) heating the substrate with the catalyst layer thereon at a temperature in an approximate range from 500° C. to 740° C. in a furnace with a protective gas therein; and (a5) supplying a carbon source gas to the furnace for about 5 to 30 minutes and growing a super-aligned array of carbon nanotubes on the substrate.

In step (a1), the substrate can be a P-type silicon wafer, an N-type silicon wafer, or a silicon wafer with a film of silicon dioxide thereon. Preferably, a 4-inch P-type silicon wafer is used as the substrate. In step (a2), the catalyst can, advantageously, be made of iron (Fe), cobalt (Co), nickel (Ni), or any alloy thereof.

In step (a4), the protective gas can, beneficially, be made up of at least one of nitrogen (N₂), ammonia (NH₃), and a noble gas. In step (a5), the carbon source gas can be a hydrocarbon gas, such as ethylene (C₂H₄), methane (CH₄), acetylene (C₂H₂), ethane (C₂H₆), or any combination thereof.

The super-aligned array of carbon nanotubes can, opportunely, have a height of about more than 100 microns and includes a plurality of carbon nanotubes parallel to each other and approximately perpendicular to the substrate. The super-aligned array of carbon nanotubes formed under the above conditions is essentially free of impurities, such as carbonaceous or residual catalyst particles. The carbon nanotubes in the super-aligned array are closely packed together by the van der Waals attractive force. The carbon nanotube array can be selected from a group consisting of single-walled carbon nanotube array, double-walled carbon nanotube array, and multi-walled carbon nanotube array.

In step (b), the material of the base material layer 12 can be selected from a group consisting of metal material, metal oxide material, semiconductor material, and polymer material. The metal material can be selected from a group consisting of silver, indium, gold, and copper. The metal oxide material can be selected from a group consisting of indium tin oxide, magnesium oxide, and titanium dioxide. The semiconductor material can be selected from a group consisting of gallium arsenide, aluminum arsenide, and aluminum sulfide. The polymer material can be selected from a group consisting of conjugate (conductive) polymers, thermal/pressure-sensitive polymer, and epoxy resin. In the present embodiment, the base material layer 12 is copper foil and is approximately the same size and shape as the carbon nanotube array. Since the carbon nanotubes are essentially free of impurities when prepared by the present method and are adhesive, the base material layer can be firmly adheres to the carbon nanotube array.

In step (c), a pressing device is used to apply a pressure on the carbon nanotube array with the base material layer 12 covered thereon. Understandably, in the process of pressing, the carbon nanotubes will, beneficially, tilt, thereby forming a carbon nanotube layer 14 having a free-standing structure. The carbon nanotubes in the free-standing structure are nearly all parallel to a surface of the carbon nanotube layer 14, and are isotropically arranged, arranged along a fixed direction, or arranged along different directions. In the present embodiment, the pressing device can, advantageously, be a pressure head. The pressure head has a glossy surface. It is to be understood that, the shape of the pressure head and the pressing direction can, opportunely, determine the direction of the carbon nanotubes arranged in the carbon nanotube layer 14. Specifically, when a planar pressure head is used to press the carbon nanotube array along the direction perpendicular to the substrate, a carbon nanotube layer 14 having a plurality of carbon nanotubes isotropically arranged can, advantageously, be obtained. When a roller-shaped pressure head is used to press the carbon nanotube array along a fixed direction, a carbon nanotube layer 14 having a plurality of carbon nanotubes aligned along the fixed direction is obtained. When a roller-shaped pressure head is used to press the carbon nanotube array along different directions, a carbon nanotube layer 14 having a plurality of carbon nanotubes aligned along different directions is obtained.

It is to be understood that, a degree of the slant of the carbon nanotubes in the carbon nanotube layer 14 is related to the pressure. The greater the pressure, the greater the degree of slant. A thickness of the carbon nanotube layer 14 is opportunely determined by the height of the carbon nanotube array and the pressure. That is, the higher the height of the carbon nanotube array and the less the pressure, the greater the thickness of the carbon nanotube layer 14.

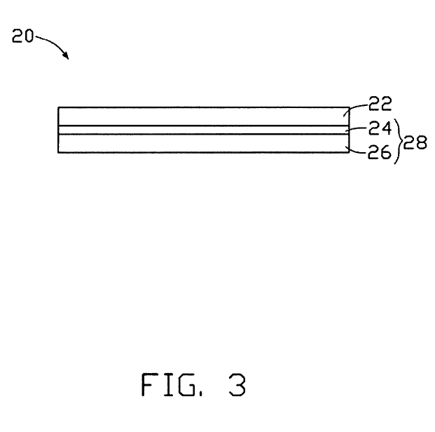

Referring to FIG. 3, a carbon nanotube composite film 20, according to a second embodiment, has a three-layer structure and includes a carbon nanotube layer 24, a first base material layer 24 and a second base material layer 26. The carbon nanotube layer 24 is disposed between the first base material layer 24 and the second base material layer 26, and combined firmly by van der Waals attractive force therebetween. The carbon nanotube layer 24 has a free-standing structure. The carbon nanotubes in the free-standing structure are nearly all parallel to a surface of the carbon nanotube layer 24, and are isotropically arranged, arranged along a fixed direction, or arranged along different directions.

A method for making the three-layer carbon nanotube composite film 20 includes the steps of: (d) preparing a two-layer carbon nanotube composite film 28, the two-layer carbon nanotube composite film 28 having a carbon nanotube layer 24 and a second base material layer 26; (e) covering the first base material layer 22 on the carbon nanotube layer 24 of the two-layer carbon nanotube composite film 28; and (f) pressing the two-layer carbon nanotube composite film 28 with the first base material layer 22 covered thereon by the pressing device of the first embodiment to acquire a three-layer carbon nanotube composite film 20.

In step (d), the carbon nanotube layer 24 and the second base material layer 26 are combined by van der Waals attractive force. In step (f), after the pressing, the first base material layer 22 is combined with the carbon nanotube layer 24 by van der Waals attractive force.

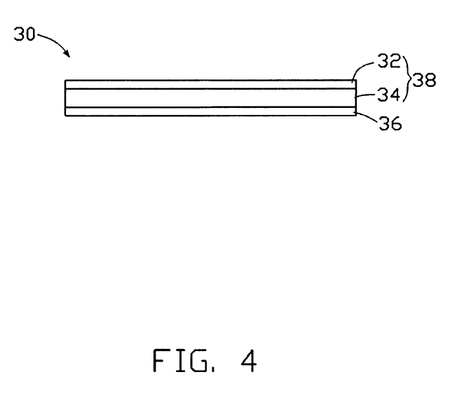

Referring to FIG. 4, a carbon nanotube composite film 30, according to a third embodiment, has a three-layer structure and includes a first carbon nanotube layer 32, a second carbon nanotube layer 36 and a base material layer 34. The base material layer 34 is disposed between the first carbon nanotube layer 32 and the second carbon nanotube layer 36, and combined firmly by van der Waals attractive force therebetween. The first carbon nanotube layer 32 and the second carbon nanotube layer 36 both have a free-standing structure. The carbon nanotubes in the free-standing structure are nearly all parallel to surfaces of the first carbon nanotube layer 32 and the second carbon nanotube layer 36, and are isotropically arranged along a fixed direction, or arranged along different directions.

A method for making the three-layer carbon nanotube composite film 30 includes the steps of: (g) preparing a two-layer carbon nanotube composite film 38, the two-layer carbon nanotube composite film 38 having a first carbon nanotube layer 32 and a base material layer 34; (h) covering a side of the two-layer carbon nanotube composite film 38 with the base material layer 34 thereon on another carbon nanotube array; and (i) pressing the another carbon nanotube array with the two-layer carbon nanotube composite film 38 covered thereon by the pressing device of the first embodiment to acquire a three-layer carbon nanotube composite film 30.

In step (g), the carbon nanotube layer 32 and the base material layer 34 are combined by van der Waals attractive force. In step (i), after the pressing, a second carbon nanotube layer 36 is acquired and the second carbon nanotube layer 36 is combined with the base material layer 34 by van der Waals attractive force.

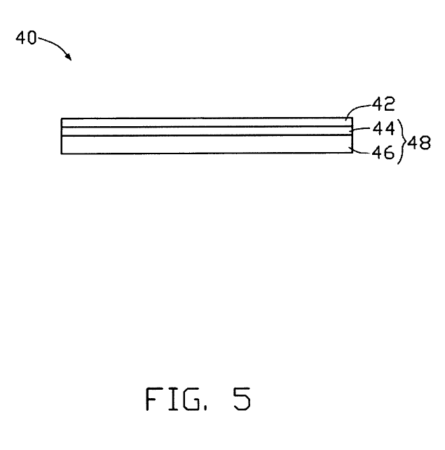

Referring to FIG. 5, a carbon nanotube composite film 40, according to a fourth embodiment, has a three-layer structure and includes a first carbon nanotube layer 42, a second carbon nanotube layer 44, and a base material layer 46. The second carbon nanotube layer 44 is disposed between the first carbon nanotube layer 42 and the base material layer 46, and combined firmly by van der Waals attractive force therebetween. The first carbon nanotube layer 42 and the second carbon nanotube layer 46 both have a free-standing structure. The carbon nanotubes in the free-standing structure are nearly all parallel to surfaces of the first carbon nanotube layer 42 and the second carbon nanotube layer 44, and are isotropically arranged along a fixed direction, or arranged along different directions. The arranged direction of the carbon nanotubes in the first carbon nanotube layer 42 and the carbon nanotubes in the second carbon nanotube layer 44 are same or different.

A method for making the three-layer carbon nanotube composite film 40 includes the steps of: (j) preparing a two-layer carbon nanotube composite film 48, the two-layer carbon nanotube composite film 48 having a second carbon nanotube layer 44 and a base material layer 46; (k) covering a side of the two-layer carbon nanotube composite film 38 with the second carbon nanotube layer 44 thereon on another carbon nanotube array; and (I) pressing the another carbon nanotube array with the two-layer carbon nanotube composite film 48 covered thereon by the pressing device of the first embodiment to acquire a three-layer carbon nanotube composite film 40.

In step (j), the carbon nanotube layer 32 and the base material layer 34 are combined by van der Waals attractive force. In step (I), after the pressing, a first carbon nanotube layer 42 is acquired and the second carbon nanotube layer 44 is combined with the first carbon nanotube layer 42 by van der Waals attractive force.

It can be understood that a multi-layer of carbon nanotube composite film can be prepared by the present embodiments according to actual uses/applications. The multi-layer of carbon nanotube composite film includes a plurality of carbon nanotube layers and a plurality of base material layer. The carbon nanotube layers can be overlapped with each other directly and combined via van der Waals attractive force.

The carbon nanotube composite film and methods for making the same have the following virtues: firstly, the method for making the carbon nanotube composite film adopting a pressing device and applying a pressure directly on the carbon nanotube array covered by a base material layer, is simple; secondly, the carbon nanotubes in the carbon nanotube composite film can be isotropically arranged, arranged along a fixed direction, or arranged along different directions and the arranged directions can be regulated by controlling the pressing head and the directions of pressing; and thirdly the carbon nanotubes in the carbon nanotube composite film are uniform and thus the carbon nanotube composite film has good mechanical strength and toughness.

Finally, it is to be understood that the above-described embodiments are intended to illustrate rather than limit the invention. Variations may be made to the embodiments without departing from the spirit of the invention as claimed. The above-described embodiments illustrate the scope of the invention but do not restrict the scope of the invention.

What is claimed is:

1. A carbon nanotube composite film comprises:
at least one carbon nanotube layer, the carbon nanotube layer having a free-standing structure constituted by a plurality of carbon nanotubes parallel to a surface of the carbon nanotube layer; and
at least one base material layer firmly combined with the carbon nanotube layer by van der Waals attractive force therebetween.

2. The carbon nanotube composite film as claimed in claim 1, wherein the carbon nanotubes in the carbon nanotube layer are isotropically arranged along a fixed direction, or arranged along different directions.

3. The carbon nanotube composite film as claimed in claim 1, wherein a thickness of the carbon nanotube layer is in an approximate range from 1 micrometer to 1 millimeter.

4. The carbon nanotube composite film as claimed in claim 1, wherein the material of the base material layer can be selected from a group consisting of metal material, metal oxide material, semiconductor material, and polymer material.

5. A method for making a carbon nanotube composite film, the method comprises the steps of:
(a) providing a substrate having a carbon nanotube array formed thereon;
(b) providing a base material layer, and covering the base material layer on the carbon nanotube array; and
(c) providing a pressing device, and pressing the carbon nanotube array with the base material layer covered thereon by the pressing device to form a carbon nanotube layer and thus acquiring a carbon nanotube composite film.

6. The method as claimed in claim 5, wherein in step (a), a height of the carbon nanotube array is more than approximately 100 microns.

7. The method as claimed in claim 5, wherein in step (a), the carbon nanotube array can be selected from a group consisting of single-walled carbon nanotube array, double-walled carbon nanotube array, and multi-walled carbon nanotube array.

8. The method as claimed in claim 5, wherein in step (c), the pressing device is a pressure head.

9. The method as claimed in claim 8, wherein in step (c), when the pressure head is planar and is used to press the carbon nanotube array along a direction perpendicular to the substrate, a carbon nanotube layer having a plurality of carbon nanotubes isotropically arranged can, advantageously, be obtained.

10. The method as claimed in claim 8, wherein in step (c), when the pressure head is roller-shaped and is used to press the carbon nanotube array along a fixed direction, a carbon nanotube layer having a plurality of carbon nanotubes aligned along the fixed direction is obtained.

11. The method as claimed in claim 8, wherein in step (c), when the pressure head is roller-shaped and is used to press the carbon nanotube array along different directions, a carbon nanotube layer having a plurality of carbon nanotubes aligned along different directions is obtained.

12. The method as claimed in claim 5, further comprising a step of covering another base material layer on the carbon nanotube composite film and pressing the carbon nanotube composite film with the base material layer covered thereon by a pressing device to acquire a multi-layer carbon nanotube composite film.

13. The method as claimed in claim 5, further comprising a step of covering the carbon nanotube composite film on another carbon nanotube array and pressing the carbon nanotube array with the carbon nanotube composite film covered thereon by a pressing device to acquire a multi-layer carbon nanotube composite film.
